(19) United States
(12) Patent Application Publication
(10) Pub. No.: US 2006/0055235 A1
(43) Pub. Date: Mar. 16, 2006

(54) Braking device adjustment method

(75) Inventors: Juan Simon Bacardit, Barcelone (ES); Bruno Berthomieu, Barcelone (ES); Fernando Sacristan, Barcelone (ES); Leon Tomas, Barcelone (ES)

Correspondence Address: Leo H McCormick;Robert Bosch Corporation, 2112 Mishawaka Avenue, P O Box 4721, South Bend, IN, 46637, US

(73) Assignee: Bosch Sistemas de Frenado, S.L., Barcelone 6 (ES)

(21) Appl. No.: 10/535,881

(22) PCT Filed: Nov. 14, 2003
(86) PCT No.: PCT/EP03/12753

§ 371 Date: May 21, 2005

(30) Foreign Application Priority Data
Nov. 22, 2002 (FR) 02/14783

(51) Int. Cl. B60T 8/34

(52) U.S. Cl. 303/113.3; 303/115.1

(57) ABSTRACT

A method and device for adjusting the dead travel of a booster (12) and master cylinder (30) assembly by adjusting the length of a push rod (26) connecting the piston (20) of the booster to a piston (28) of the master cylinder. The length of the push rod (26) being adjusted by plastic deformation in axial compression.

The invention relates to a method for adjusting the dead travel of a master cylinder and pneumatic booster assembly in a braking device, particularly for a motor vehicle.

The pneumatic booster of a braking circuit comprises a rigid envelope in which two chambers are delimited and separated from one another by a moving partition bearing an axial piston, one of these chambers being connected to a vacuum source and the other being placed selectively in communication with the first chamber or with the surrounding atmosphere.

The piston is interposed between a control rod moved in axial translation in the booster by the brake pedal, and a push rod acting on a piston of the master cylinder to move it in a chamber of the master cylinder when the control rod is itself moved by the brake pedal, and to cause the pressure on the output side of the master cylinder to rise.

There is, in the master cylinder and booster system, some dead travel that needs to be reduced and controlled, so that action on the vehicle brake pedal causes the brakes to be applied as swiftly as possible. For this purpose, the push rod which is mounted in the booster between the piston of the booster and the piston of the master cylinder is often made in two parts which are telescopic and/or screwed one to the end of the other so that, in each master cylinder and booster assembly, the dead travel can be adjusted to an appropriate value by altering the length of the push rod.

This adjustment therefore entails precise screwing or unscrewing of the two parts of the push rod, the tightening of a locking member and possibly the use of shims or washers of different thicknesses. These adjustment operations are relatively painstaking and lengthy and therefore expensive.

It is a particular object of the invention to simplify these operations and reduce their cost.

The invention therefore proposes a method for adjusting the dead travel of a master cylinder and pneumatic booster assembly belonging to a braking device, particularly for a motor vehicle, in which a piston of the booster is connected via a push rod to a piston of the master cylinder, characterized in that it consists in modifying the length of the push rod by plastic deformation of at least part of this rod, this deformation being obtained by axial compression of the push rod.

The method according to the invention therefore avoids any screwing-unscrewing operation and any operation of tightening a locking member and additionally has the advantage, that the push rod is set to the desired length in a precise way and in a single compression operation, without the risk of this setting subsequently being lost.

Setting the desired dead travel in a master cylinder-booster assembly is thus simpler and less expensive than it was in the prior art.

According to another characteristic of the invention, this method consists in measuring an axial distance between the piston of the booster in the rest position and a predetermined part of the envelope of the booster, subtracting from this first distance a second distance dependent on the desired dead travel, and axially compressing the push rod until Wits length is equal to the result of the aforementioned subtraction.

It is therefore very simple and quick to determine what length should be given to the push rod.

According to yet another characteristic of the invention, a tubular spacer piece, through which the push rod passes axially with clearance, is inserted between two stop pieces accommodating the ends of the push rod, this tubular spacer piece having an axial dimension determined so that the push rod has the desired length when the aforementioned stop pieces and the spacer piece are pressed together.

Of course, use may advantageously be made of just one spacer piece of a determined axial length, and washers of different thicknesses will be added to it in order to give an overall length tailored to each specific case.

The invention also proposes a device for executing this method, characterized in that it comprises stop pieces comprising cylindrical housings in which the ends of the push rod are engaged, and compression means, for example of the hydraulic type, accommodating the stop pieces to push them axially towards each other.

Advantageously, this device also comprises a tubular spacer piece inserted between the stop pieces and intended to have the push rod pass axially through it with clearance, the axial length of this spacer piece being determined as a function of the axial length to be given to the push rod.

The invention also proposes a push rod for a pneumatic booster of a braking device, this rod being intended to be mounted between a piston of the booster and a piston of a master cylinder, the rod being characterized in that at least part of this push rod has shape and/or material characteristics that facilitate its plastic deformation in axial compression.

The invention also proposes a master cylinder and pneumatic booster assembly for a braking device, particularly for a motor vehicle, characterized in that it comprises a push rod, the axial length of which has been adjusted by executing the aforementioned method or by means of the aforementioned device.

The invention will be better understood and other characteristics, details and advantages thereof will become more clearly apparent from reading the description which follows, given by way of example with reference to the attached drawings in which:

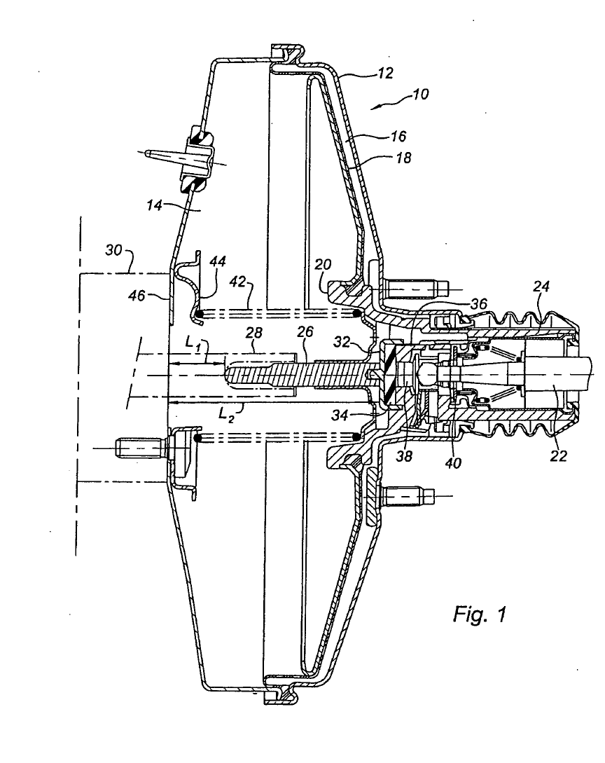

FIG. 1 is a schematic view in axial section of a pneumatic booster;

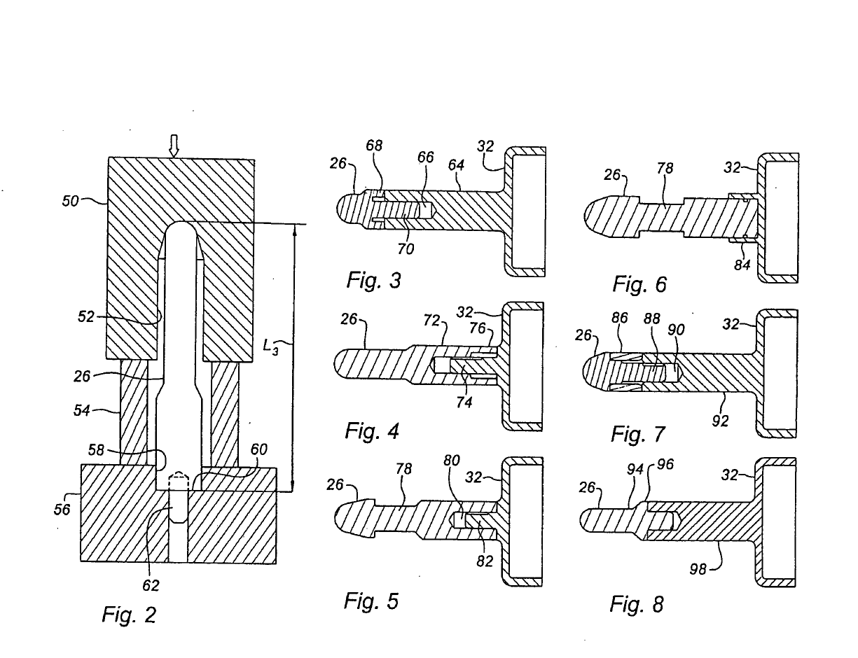

FIG. 2 is a schematic view in axial section of a device for adjusting the length of the push rod;

FIGS. 3 to 8 are schematic views in axial section of various embodiments of a push rod.

In the description which follows, everything depicted to the left in FIGS. 1 and 3 to 8 will be described as being at the front, and everything depicted to the right will be described as being at the rear.

The pneumatic booster 10 for a braking device, depicted schematically in FIG. 1, essentially comprises a rigid envelope 12 in which a front chamber 14 and a rear chamber 16 are separated in a sealed fashion from one another by a moving partition 18 which bears an axial piston 20.

The front chamber 14 is intended to be connected to a source of vacuum while the rear chamber 16 is selectively placed in communication with the front chamber 14, when there is no braking, and with the ambient atmosphere when there is braking.

The axial piston 20 of the booster is inserted between a control rod 22 moved axially within a rear tubular part 24 of the piston 20 by a brake pedal, not depicted, and a push rod 26 which extends axially forwards and cooperates with a piston 28 of a master cylinder, depicted in outline, the push rod 26 being pushed at its rear end onto a bowl 32 bearing a reaction disc 34 made of a more or less incompressible material such as rubber or elastomer for example, on which there bear a front part 36 of the piston 20 and a plunger 38 mounted at the front end of the control rod 22. The rear end of the plunger 38 cooperates with an annular shutter 40 of a three-way valve mounted in the rear tubular part 24 of the piston and, depending on the axial position of the control rod 22 actuated by the brake pedal, allowing the rear chamber 16 to be placed selectively in communication with the front chamber 14 or with the ambient atmosphere, in a way well known to those skilled in the art.

The piston 20 of the booster is constantly returned to its position of rest depicted in FIG. 2 where it is in abutment against a fixed part of the envelope 12, by a return spring 42 mounted axially in the front chamber 14 between the piston 20 and a seat 44 integral with the front wall 46 of the envelope 12 of the booster.

To adjust the dead travel of the booster 10 and master cylinder 30 assembly, the length of the push rod 26 pushed onto the bowl 32 can be adjusted so that its front end is a distance L1 from the external face of the front radial wall 46 of the envelope of the booster, on which the master cylinder 30 is mounted as depicted in FIG. 1.

To adjust the length of the push rod 26, the length L2 between the front face of the bowl 32 and the external face of the front radial wall 46 is measured and the push rod 26 is given the length L3=L2−L1.

To this end, the push rod 26 comprises at least one part whose shape and/or material characteristics facilitate its plastic deformation in axial compression.

The compression device according to the invention comprises (FIG. 2), an upper stop piece 50 comprising a blind cylindrical axial passage 52 in which the front part of the push rod 26 is engaged, an intermediate piece or spacer piece 54 of tubular cylindrical shape through which the central part of the push rod 26 passes with clearance, and a lower stop piece 56 comprising an axial cylindrical passage 58 accommodating and centring the rear part of the push rod 26, this axial passage 58 comprising a shoulder 60 on which the rear end face of the push rod 26 bears axially.

The assembly 50, 54, 56 containing the push rod 26 is placed for example on a hydraulic press that allows enough axial force to be applied to these pieces to reduce the length of the rod 26 to the desired value L3, at which value the pieces 50, 54 and 56 press on one another. Washers of calibrated thickness may possibly be added to the spacer piece 54.

The part of the push rod 26 which is plastically deformed in order to obtain the length L3 may be either its front part or its central part or its rear part, as depicted schematically in FIGS. 3 to 8.

When the rear end of the push rod 26 comprises a blind axial orifice for forcibly fitting onto an axial stud of the bowl 32 as depicted in FIG. 1, a male piece 62 may be mounted in this blind orifice, as depicted in FIG. 2, to prevent it deforming during axial compression of the push rod.

In the embodiment depicted in FIG. 3, the bowl 32 comprises an axial cylindrical shank 64 directed forwards and its front end comprising a blind cylindrical passage 66. The push rod 26 at its rear part comprises a cylindrical skirt 68 for bearing against the front end of the cylindrical shank 64 of the bowl 32, this cylindrical skirt 68 constituting the part of the push rod that can be deformed in axial compression, and an axial cylindrical shank 70 extending rearwards for the force-fitting of the push rod 26 into the hole 66 in the cylindrical shank 64 of the bowl 32.

In the embodiment of FIG. 4, the push rod 26 comprises a rear cylindrical skirt 72 by means of which it is push-fitted onto an axial stud 74 of the bowl 32. The rear part of the cylindrical skirt 72 has a thinner wall and forms the region of preferential deformation of the push rod 26 in axial compression.

In the embodiment of FIGS. 5 and 6, it is the central part 78 of the push rod 26 which has an outside diameter smaller than that of the rest of the push rod and constitutes the region of preferential deformation in axial compression. In FIG. 5, the rear end of the push rod 26 comprises a blind cylindrical axial passage 80 for mounting by push-fitting on to an axial cylindrical stud 82 of the bowl 32. In FIG. 6, the rear end of the bowl 26 is solid cylindrical and is forcibly push-fitted into an axial tubular sleeve 84 belonging to the bowl 32.

In FIG. 7, the part of preferential deformation of the push rod 26 is a sleeve 86 attached to an axial cylindrical shank 88 of the rod allowing it to be mounted by forcibly push fitting in a blind cylindrical passage 90 of an axial cylindrical shank 92 of the bowl 32.

In the embodiment of FIG. 8, it is the front part 94 of the push rod 26 which has an outside diameter smaller than that of its rear part 96 for mounting on an axial cylindrical shank 98 of the bowl 32 and which constitutes the part of the push rod that undergoes preferential deformation under axial compression.

Other configurations may of course be given to the push rod 26 by those skilled in the art, provided that they allow a precise reduction in its length under axial compression.

What is claims is:

1. A method for adjusting the dead travel of a master cylinder and pneumatic booster assembly belonging to a braking device for a motor vehicle, in which a first piston (20) of the booster is connected via a push rod (26) to a second piston (28) of the master cylinder (30), characterized by modifying the length of a push rod (26) by plastic deformation through axial compression of said push rod.

2. The method according to claim 1, characterized by a step of measuring an axial distance (L2) between the piston (20) of the booster in the rest position and a predetermined part of the envelope (12) of the booster, subtracting from this distance (L2) from another axial distance (L1) dependent on the desired dead travel, and axially compressing the push rod until its axial length (L3) is equal to the result of the aforementioned subtraction.

3. The method according to claim 1, characterized in that the ends of the push rod (26) are received and guided in cylindrical passages (52, 58) of stop pieces (50, 56).

4. The method according to claim 3, characterized in that a tubular spacer piece (54), through which the push rod (26) passes axially with clearance, is inserted between the stop pieces (50, 56).

5. The method according to claim 4, characterized by a step to determine the axial length of the spacer piece (54) as a function of the desired length (L3) of the push rod (26) and axially compressing the push rod until the spacer piece (54) is clamped between the stop pieces (50, 56).

6. The method according to claim 5, characterized by a step of adjusting the axial length of the spacer piece (54) by adding washers of different thicknesses.

7. The method according to claim 2, characterized in that the first axial distance (L2) is measured between a bowl (32) housing a reaction disc (34) mounted at the end of the piston (20) of the booster and an external radial face (46) of the booster envelope, on the same side as the master cylinder (30).

8. The method according to claim 7, characterized in that said push rod, a part (68, 76, 78, 86, 94) has a shape and/or material characteristics that facilitate its plastic deformation in axial compression.

9. The method of claim 8 wherein said stop pieces (50, 56) have cylindrical passages (52, 58) in which the ends of the push rod (26) are engaged, and compression means accommodating the stop pieces (50, 56) to push them axially towards each other.

10. The method according to claim 9, characterized in a tubular spacer piece (54) is inserted between the stop pieces (50, 56) and the push rod (26) pass axially through the spacer with clearance such that the axial length of the spacer piece is determined as a function of the axial length (L3) to be given to the push rod.

11. The method according to claim 10, characterized in that washers of different thicknesses are added axially to the spacer piece (54) in order to adjust its length.

12. A push rod for a pneumatic booster of a braking device for a motor vehicle, said rod being mounted between a first piston (20) of the booster and a second piston (28) of an associated master cylinder, the rod being characterized in that at least part of said push rod has a shape and/or material characteristics that facilitate plastic deformation in response to axial compression to achieve a desired length (L3).

13. A master cylinder and pneumatic booster assembly of a braking device for a motor vehicle, characterized by a push rod (26) having an axial length (L3) of which has been adjusted by axial compression.

14. The assembly according to claim 13, characterized in that the push rod (26) is mounted by force-fitting onto a bowl (32) housing a reaction disc (34) of the booster.
